(19) United States
(12) Patent Application Publication
(10) Pub. No.: US 2011/0036861 A1
(43) Pub. Date: Feb. 17, 2011

(54) LIQUID DISPENSING SYSTEM WITH TEMPERATURE CONTROL

(75) Inventors: Ram Hillel, Misgav Yuvalim (IL); Daniel Shaaf, D.N Misgav (IL); Ram Shalvi, Ramat Hasharon (IL); Joed Avni, Ramat Hasharon (IL)

Correspondence Address: OLIFF & BERRIDGE, PLC, P.O. BOX 320850, ALEXANDRIA, VA, 22320-4850, US

(73) Assignee: COOLTEK 2 GO LTD., JORDAN VALLEY (IL)

(21) Appl. No.: 12/988,091

(22) PCT Filed: Apr. 16, 2009
(86) PCT No.: PCT/IL2009/000413

§ 371 Date: Oct. 15, 2010

Related U.S. Application Data
(60) Provisional application No. 61/071,174, filed on Apr. 16, 2008.

(51) Int. Cl. B67D 7/80

(52) U.S. Cl. 222/54

(57) ABSTRACT

The present invention provides an on-demand liquid cooling/heating system, comprising: a liquid outlet for dispensing liquid to a user; a conduit system for flow communication between a liquid reservoir and the liquid outlet; a temperature control device disposed in the conduit system for controlling the temperature of liquid flowing therethrough, and comprising a thermoelectric temperature control device linked to an electric power source and to a control module for controlling the operation of the temperature control device; and a sensor for sensing liquid demand and for activating the temperature control module upon sensing a demand.

### FIELD OF THE INVENTION

This invention relates to a liquid dispensing system with a temperature control device for cooling or heating, of the dispensed liquid.

### BACKGROUND OF THE INVENTION

Outdoors activities require portable hydration solutions for the replenishment of water lost through sweating and for quenching of thirst. The old traditional canteens have evolved to plastic liquid bottles and further into backpack pouches equipped with a hose which has a mouthpiece at its end, commonly known as “camelbaks”. The camelbacks are comfortable, can hold a relatively large volume of liquid and free the user from the need to hold a bottle, thus allowing him to drink in a more or less continuous manner.

It is often more desirable to have the liquid at a higher or lower than ambient temperature, depending on the circumstances. On a warm day it is preferable to consume a chilled drink. On a cold day, while skiing for example, it may be desirable to consume a warm drink. Furthermore, having a liquid at a non-ambient temperature may assist in thermo-regulating the body. It has also been shown that the performance of individuals engaged in sports (e.g. athletes, cyclists, motorcyclists, sport drivers, wind surfers, etc.) as well as combat soldiers is improved when chilled liquids are consumed, since these encourage and enable drinking larger volumes.

Several approaches are known in the art of providing temperature controlled liquids in portable systems. Liquid containing pouches, as described in U.S. Pat. No. 5,060,833, have a feeding opening wide enough to allow the addition of ice cubes, and it is often made of a material which is at least partially thermo-insulating. WO 02/017745 describes a pouch having exterior and interior portions which are closely associated. The interior portion holds the consumable liquid which is chilled or heated by a temperature regulating medium installed in the exterior portion. The whole pouch fits into an insulated backpack. US 2006/0151534 describes a portable hydration system comprising a heating element attached to a hose close to the mouthpiece for preventing the liquid from freezing. The heating element is optionally coupled to an on/off switch or to the heating control element.

Chilling liquids may be achieved by means of a Peltier unit. JP 172425 describes a conduit passing through a cold side and/or a hot side of a Peltier unit. GB 2,397,117 and U.S. Pat. No. 6,370,884 both describe a dispensing apparatus of beer or water comprising a reservoir or a cartridge containing the beverage, which are chilled by Peltier units monitored by temperature sensing device. US 2004/0098991 describes a Peltier unit which is integral with a heat conducting surface, which is in contact with flow lines of liquids, with optional temperature, pressure or flow control sensors printed thereunto—controlling the temperature of the fluid.

### SUMMARY OF THE INVENTION

In accordance with the teaching herein, a new liquid dispensing system is provided which can be portable and is capable of providing liquid, particularly potable water, at a controlled temperature; for example, chilled liquids in a hot environment and warm liquids in a cold environment. One challenge overcome by the teaching herein is the provision of a temperature controlled liquid dispensing system with low power consumption. In accordance with the invention, this is achieved by activating a temperature control device disposed in a conduit system converting liquid from a reservoir to a liquid dispensing outlet, only upon sensing a demand for it (by the user).

The liquid dispensing system, according to some embodiments, is a portable personal system. In accordance with other embodiments, the liquid dispensing system is installed in a vehicle, e.g. car, bicycle, an armored personnel carrier, etc.

The present teaching thus provides an on-demand liquid cooling or heating system, comprising: a liquid outlet for dispensing liquid to a user; a conduit system for flow communication between the reservoir and the outlet; a temperature control device disposed in the conduit system; and at least one sensor. In the context of the present invention it is to be understood that the term “on demand” includes liquid dispensing immediately after sensing demand for same; immediately typically meaning not more than 2-5 seconds.

The temperature control device controls the temperature of the liquid flowing therethrough and comprises a thermoelectric temperature control element linked to an electric power source, e.g. a battery, and as well as to a control module for controlling the operation of the temperature control device. The sensor senses liquid demand and induces the control module to activate said temperature control device.

The on-demand liquid cooling or heating system may comprise an integral reservoir connected to the conduit system. Alternatively, the conduit system may be equipped with a fast connector, e.g. a universal connector, for easy connection of the system to water bottles, canteens, liquid pouches etc.

A demand-induced activation may be through a demand-detection sensor, e.g. a pressure sensor disposed in the liquid conduit system that senses a reduction in pressure within the conduit system as a result of a sucking action by the user. Such sensing thus activates the control module during the period of suction, thereby cooling or heating only the portion of liquid being consumed ad hoc that is flowing through the control module. It is also possible to induce, upon such sensing, cooling or heating for a defined time period, e.g. several seconds or several tens of seconds.

The principle of activating the control module only upon demand, while controlling the temperature of only the liquid that flows out of the reservoir through the conduit system and out through the dispensing outlet, may save power required for the temperature control module operation as compared to liquid dispensing systems (including portable liquid dispensing systems) that operate in a batch mode to heat or cool a liquid contained in a temperature controlled liquid reservoir. A system in accordance with the teaching herein may thus perform effectively with a relatively small power source, e.g. a battery. The battery may be rechargeable or non-rechargeable (i.e. replaceable). The power source may be rechargeable either by some embodiments of the present disclosure, by solar panels, a motion-induced generator, or a spring generator etc. The battery may be connected to a capacitor to allow on demand discharge of power.

In addition to a pressure sensor, given as an example above, other sensors may also be used in accordance with the teaching herein, such as a flow sensor (sensing flow of liquid) or photovoltaic/optical sensor (sensing a change in the reflective index in the presence of liquid) or capacitance sensor (sensing the presence of liquid) or a conductivity sensor. Upon liquid demand (e.g. suction of liquid via the liquid conduit), liquid begins to flow into the conduit system and the sensor then senses the flow of the liquid and activates the temperature control device. Needless to say that when the consumer ceases to suck and thus pressure rises in the conduit system, e.g. back to atmospheric pressure, or there is no liquid flow in the conduit, the sensor may deactivate or cease to activate the temperature control device. As noted above, the activity may also be timed whereby the temperature control device will be automatically deactivated or cease activity after a defined time period.

In accordance with an embodiment of the teaching herein, the system also includes a filtering unit which is disposed in the conduit system, typically at the portion thereof upstream to the temperature control device thereby protecting the temperature control device from the particulate matter present in the liquid (at this location also protection of the temperature control device is achieved, albeit, such protection may be achieved by the use of several filtering units located upstream as well as downstream the temperature control device). The filtering unit is adapted to filter out particulate matter, sediments, harmful residues, mal-odorant, substance that impart bad taste, or a variety of substances (e.g. heavy metals) which may be harmful and present in liquid obtained from low quality sources, such as brackish water, contaminated streams, etc.

The filtering unit may also include a disinfecting unit that may be powered by the system's power source. The disinfecting unit may be, without being limited thereto, a UV-based, a boiling-based, an ozone-based disinfecting unit or any other commercially available disinfecting unit. At times, e.g. when using a UV-based disinfecting unit or any other power consuming disinfecting unit, the latter may be activated to begin its disinfection process upon sensing a liquid demand, namely, concomitantly with the activation of the temperature control device. The control module for such a disinfecting unit may be combined with that for the temperature control device.

The filtering unit may be integrally installed within the on-demand liquid cooling or heating system of the invention and may have replaceable components. The filter unit may also, in some embodiments of the invention, be equipped with a filtering unit that may be connected or bi-passed in use, depending on liquid quality, or the latter may be equipped with a connector for connecting the system to a commercially available filtering unit.

As may be appreciated, liquid, particularly water remaining in the conduit system for an extended period of time, may be a fertile ground for bacteria and other microorganisms growth, thus, in accordance with one embodiment, the system also includes a return flow sub-system that serves to evacuate non-consumed liquid from at least a portion of the conduit system. Such a return flow system may be equipped with a pump to induce a liquid backflow through the conduit system. In an alternative embodiment, the on demand temperature controlled system may comprise an auxiliary conduit system linked to the reservoir and to the conduit system for returning non-consumed liquid directly thereto.

The invention will now be further illustrated in relation to the non-limiting example, specific embodiments described below.

### BRIEF DESCRIPTION OF THE DRAWINGS

In order to understand the invention and to see how it may be produced in practice, embodiments will now be described, by way of non-limiting example only, with reference to the accompanying drawings, in which:

FIG. 1 is a schematic illustration of the main components of an on demand liquid cooling or heating system in accordance with an embodiment of the present invention.

FIG. 2 is a schematic illustration of an on demand liquid cooling or heating system in accordance with an embodiment of the present invention.

### DETAILED DESCRIPTION OF EMBODIMENTS

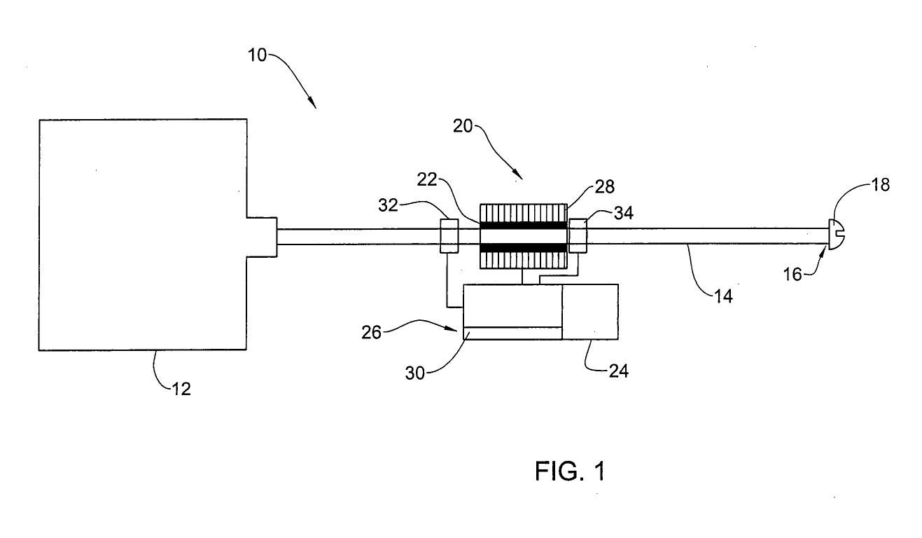

Reference is made to FIG. 1 which provides a schematic illustration of an on demand liquid cooling/heating system 10, comprising a liquid reservoir 12, which may be a bottle, a bag, a canteen, a pouch or any other container for holding therein liquid to be used by the user. The reservoir may be fitted into a back pack or any other carrying arrangement, e.g. using a fast connection arrangement. The liquid reservoir 12 is connected to a conduit system 14, comprising a tube with a first end thereof connected to reservoir 12 and a second end thereof with an outlet 16 for dispensing liquid to the user. The liquid conduit system 14 establishes flow communication of liquid between the reservoir 12 and liquid outlet 16. The liquid outlet 16 may be equipped with a dispensing mouthpiece and a valve 18, preferably a one way valve to prevent reverse flow.

While a single tube is illustrated in FIG. 1, it is noted that conduit system 14 may comprise a combination of individual number of tubes allowing flow communication of liquid between the reservoir 12 and the liquid outlet 16. The conduit system 14 may be made of continuous tubes leading from the reservoir to the outlet 16 or may consist of a number of segments, e.g. one segment from the reservoir to the temperature control device 20, a second segment extending within the temperature control device 20 and a third segment leading therefrom to the outlet 16.

As illustrated, the system 10 also comprises a temperature control device 20 disposed in the conduit system 14 for temperature control of liquid flowing therethrough. The temperature control device 20 comprises a thermoelectric temperature control element 22, for example a Peltier element, an electric power source 24 and a control module 26. The temperature control device 20 is typically associated with heat radiation elements 28. The heat radiation element 28 functions as a heat sink designed to absorb and dissipate heat emanating from the chilled liquid. To improve performance, the heat radiation element 28 may comprise a fan or a pump for increasing airflow over the heat sink (thus permitting to maintain a larger temperature gradient through quicker replacement of the warmed air than in the case of passive convection). For heating, the thermoelectric temperature control element 22 may also include a heating filament.

The control module 26 may be configured to receive data relating to one or more of the ambient temperature, the ambient relative humidity, liquid flow rate, liquid temperature in the reservoir 12 that enters the temperature control device 20, liquid temperature exiting the temperature control device 20, heat sink temperature and others. When applicable, the data may be introduced manually, e.g. for ambient temperature/relative humidity; or the data is received from dedicated temperature sensors (now shown).

At times, the control module 26 may receive data indicative of the user's (consumer's) body temperature and synchronize the operation of the temperature control device 20 with the body temperature of the user. For example, the user may carry on his skin a body temperature sensor and a transmitter, so as to continuously (or otherwise) transmit data to the control module 26 indicative of its surface body temperature.

The electric power source 24 may be one or more batteries, which may be chargeable, for example by an integrated solar panel or the one or more batteries may be removable, replaced or recharged by an extraneous source.

The temperature control device 20 may utilize pulse width modulation (PWM) to control the power level in the thermoelectric temperature control element 22, thereby preventing, e.g. underised freezing of the liquid cooled in the temperature control device 20. The temperature control device 20 may comprise more than one thermoelectric temperature control element 22. When a plurality of thermoelectric temperature control elements are used, they may be connected in parallel or in series. At times, in order to maintain a small temperature gradient, the elements 22 may be connected in cascade.

The control module may include a user interface 30 to permit the user to control the operation of the system. For example, it may include an ON/OFF switch, it may provide the user with the option to set a desired temperature or switch the system between the cooling mode and the heating mode. The user interface 30 may include an indication of the heat or cool operation mode, e.g. a green LED may be used to indicate a heating mode; a blue LED may be used to indicate a cooling mode. The user interface, by some embodiments, may display the liquid temperature, the amount of liquid remaining in the reservoir (and/or consumed by the user), the power level of the power source, temperature within the reservoir, etc. The user interface 30 may also include a keyboard or touch screen to insert into the system user's preferences, such as the desired liquid temperature, and parameters such as surrounding (ambient) temperature, surrounding relative humidity etc.

Linked to the control module 26 is also a sensor 32 disposed in the conduit system 14 (in this specific example it is located upstream to the temperature control device but it should be mentioned that it may also be located downstream therefrom) and adapted to sense a user demand for liquid. An example is a pressure sensor that senses a decrease in pressure within the conduit once the user starts sucking mouthpiece 18, with the reduction in pressure inducing the control module 26 to activate the temperature control device 20. Possible alternatives to a pressure sensor are photovoltaic, capacitance, flow, conductivity, or other sensors.

According to some embodiments of the invention, the system 10 also includes at lease one temperature sensor 34 that is connected to the control module in a feedback loop for precise temperature control.

According to some embodiments, the system 10 comprises a liquid volume sensor (not shown) for measuring the amount of liquid consumed, or alternatively, the volume of liquid remaining in the reservoir 12.

The system 10 may comprise other sensors operable with said control module 26 such as a water flow rate sensor for measuring the water flow rate in the system. Yet, in accordance with some embodiments, the system 10 may further comprise a safety valve (not shown) to prevent liquid flow in conduit 14 e.g. in case of a malfunction of one of the system's components.

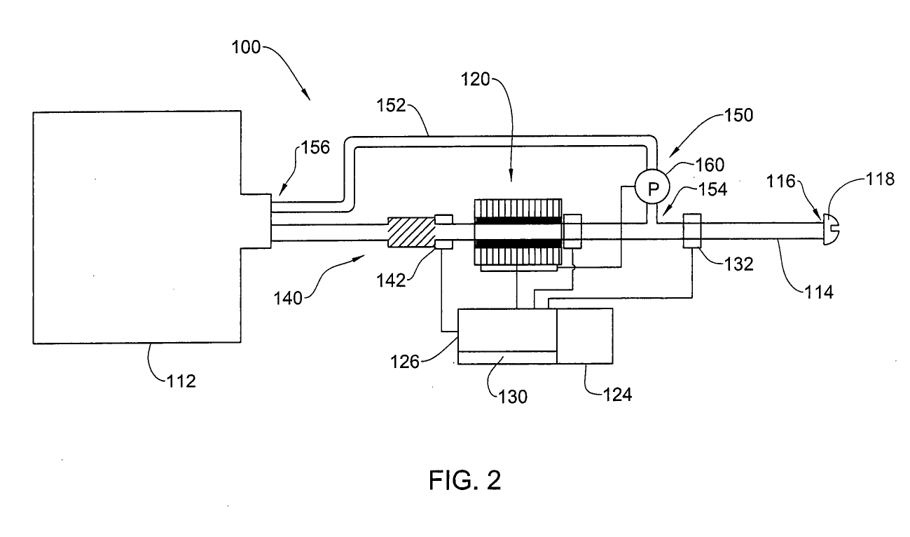

Reference is now made to FIG. 2, which schematically illustrates another embodiment of the invention. For simplicity, reference numerals similar to those used in FIG. 1, shifted by 100, are used to identify components having a similar function. For example, component 132 in FIG. 1 is a sensor with the same function as sensor 32 in FIG. 1.

The system shown in FIG. 2 further includes a filtering unit 140 disposed in the conduit system upstream to the temperature control device 120. It should however be noted that the filtering unit 140 may be disposed at other locations in the conduit system, e.g. downstream the temperature control device 120.

The filtering unit 140 may incorporate a variety of filtering means such as mesh filters, chemical filters (e.g. carbon-activated filters), magnet elements as well as any other filtering techniques known in the art of water purification for removal of particulate matter, sediments, microorganisms, heavy metals, and the like, which may be harmful or impart bad taste or malodor to the liquid. The filtering unit, according to some embodiments, may be associated with an electrically operated disinfecting unit 142, e.g. one that includes a UV light emitter, a boiler (for boiling the liquid) or an ozone reactor (that provides ozone products for disinfection).

When using a filtering unit, the user interface may also show the condition of the liquid consumed, e.g. the type of contaminants, the level of contaminates etc.; the condition of the filter, etc. and provide an alert when the liquid is of poor quality or the filter should be changed etc.

Also illustrated in FIG. 2 is a return flow sub-system 150 for evacuating non-consumed liquid from at least a portion of the conduit system. In this particular embodiment, sub-system 150 comprises an auxiliary conduit system 152 having a first end 154 in flow communication with the main liquid conduit 114 and a second end 156 leading to the reservoir, for returning non-consumed liquid into the reservoir. Return flow sub-system 150 further comprises a pump 160 powered by the power source 124, which is activated by the control circuit once no more liquid demand is sensed by the sensor. According to one embodiment, the liquid conduit 114 further comprises an air relief module (not shown) to facilitate the liquid backflow into the reservoir. The air relief module may be located at any location between the liquid outlet of reservoir 158 and mouthpiece 118. According to one embodiment the air relief is between the filtering unit 140 and the temperature control device 120. Alternatively, passive return of liquid into the reservoir may take place by way of vacuum created at the liquid inlet 156.

The conduit system 14 or at least the portion thereof downstream the temperature control device 20 may typically be heat insulated by any one of insulating materials known in the art.

The portable system may be designed to be carried on an individual's back, on vehicles (bicycles or cars) etc.

1-11. (canceled)

12. An on-demand liquid cooling/heating system, comprising:
a liquid outlet for dispensing liquid to a user;
a conduit system for flow communication between a liquid reservoir and the liquid outlet;
a temperature control device disposed in the conduit system for controlling the temperature of liquid flowing therethrough, and comprising a thermoelectric temperature control device linked to an electric power source and a control module for controlling the operation of the temperature control device; and
a sensor for sensing liquid demand and for causing activation of the temperature control module upon sensing a demand.

13. A system according to claim 12, wherein the demand detection sensor is either a pressure sensor, a flow sensor, a photovoltaic sensor, a conductivity sensor or a capacitance sensor.

14. A system according to claim 12, comprising a filtering unit disposed in the conduit system.

15. A system according to claim 14, wherein the filtering unit comprising a disinfecting unit powered by said electric power source, the disinfecting unit being one or a combination of a UV-based, boiling based or ozone based disinfecting unit.

16. A system according to claim 15, wherein the control module activates the disinfecting unit upon sensing liquid demand.

17. A system according to claim 12, comprising an integral liquid reservoir in flow communication with said conduit system.

18. A system according to claim 12, comprising a return flow sub-system for evacuating non-consumed liquid from at least a portion of the conduit system.

19. A system according to claim 18, wherein said return flow system comprises an auxiliary conduit system.

20. A system according to claim 19, wherein the auxiliary conduit system comprises a pump.

21. A system according to claim 19, wherein said auxiliary conduit system is in flow communication with said liquid reservoir adapted for returning non-consumed liquid form said cooling unit into said reservoir.

22. A system according to claim 12, being a portable system.

23. An on-demand liquid cooling/heating system, comprising:
a portable liquid outlet for dispensing portable liquid to a user;
a conduit system for flow communication between a liquid reservoir and the portable liquid outlet;
a temperature control device disposed in the conduit system for controlling the temperature of liquid flowing therethrough, and comprising a thermoelectric temperature control device linked to an electric power source and a control module for controlling the operation of the temperature control device; and
a sensor for sensing portable liquid demand and for causing activation of the temperature control module upon sensing a demand.

24. A system according to claim 23, further comprising a filtering unit disposed in the conduit system.

25. A system according to claim 24, wherein the filtering unit comprising a disinfecting unit powered by said electric power source.

26. A system according to claim 25, wherein the control module activates the disinfecting unit upon sensing liquid demand.

27. A system according to claim 23, comprising an integral liquid reservoir in flow communication with said conduit system.

28. A system according to claim 23, comprising a return flow sub-system for evacuating non-consumed liquid from at least a portion of the conduit system.

29. A system according to claim 28, wherein said return flow system comprises an auxiliary conduit system.

30. A system according to claim 29, wherein the auxiliary conduit system comprises a pump.

31. A system according to claim 29, wherein said auxiliary conduit system is in flow communication with said liquid reservoir adapted for returning non-consumed liquid form said cooling unit into said reservoir.
